(19) United States
(12) Patent Application Publication
(10) Pub. No.: US 2008/0219533 A1
(43) Pub. Date: Sep. 11, 2008

(54) Apparatus and Method For Correlating First and Second 3D Images of Tubular Object

(75) Inventor: Simona Grigorescu, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/817,690

(22) PCT Filed: Mar. 7, 2006
(86) PCT No.: PCT/IB06/50704

§ 371 Date: Sep. 4, 2007

(30) Foreign Application Priority Data
Mar. 7, 2005 (EP) 05101726.7

(51) Int. Cl. G06K 9/00

(52) U.S. Cl. 382/131

(57) ABSTRACT

A computer tomography (CT) imaging apparatus (2) for correlating images of the colon in prone and supine positions is disclosed. The apparatus comprises pairs of x-ray sources (6) and detectors (8) for generating 3 D image data representing at least one first location on the colon wall in the prone or supine position, and for generating 3 D image data representing a plurality of locations along the teniae coli extending along the colon wall in that position. The sources and detectors also generate 3 D image data representing the same locations along the teniae coli in the other of the prone or supine position. A computer (16) contains a processor (20) for determining a location in the second scanned image corresponding to the first location in the first scanned image.

The present invention relates to an apparatus and method for correlating first and second 3 D images of a tubular object, and relates particularly, but not exclusively, to an apparatus and method for correlating scanned image data of the colon in prone and supine positions. The invention also relates for a computer program product for use in such apparatus.

Investigations of colon related diseases are generally based on computer tomography (CT) imaging of the colon. A patient subjected to such investigations undergoes two CT scans, one in a prone position (i.e. face down) and one in a supine position (i.e. face up), resulting in two CT data sets. The reason for obtaining two CT scans is to eliminate the effect of residual fluid in the colon preventing image data being obtained for part of the colon wall. A radiologist then correlates the results of one data set with those of the other. This process, known as registration, suffers from the drawback of being time consuming.

By “correlation”, also known as “registration”, is meant the process of determining which part of a first image corresponds to a predetermined part of a second image.

Methods have been proposed to automatically register scans of the colon taken in prone and supine orientations. Such methods operate by building a 3 D model of the colon from 2 D images obtained from a scanner, which results in two 3 D representations of the colon, one for the prone position and one for the supine position. A centerline (also called medial axis) for each of the two 3 D colon models is then computed, and a number of reference points selected and matched for each of the two centerlines. The remaining points on the two centerlines are then matched by interpolation between the two closest reference points.

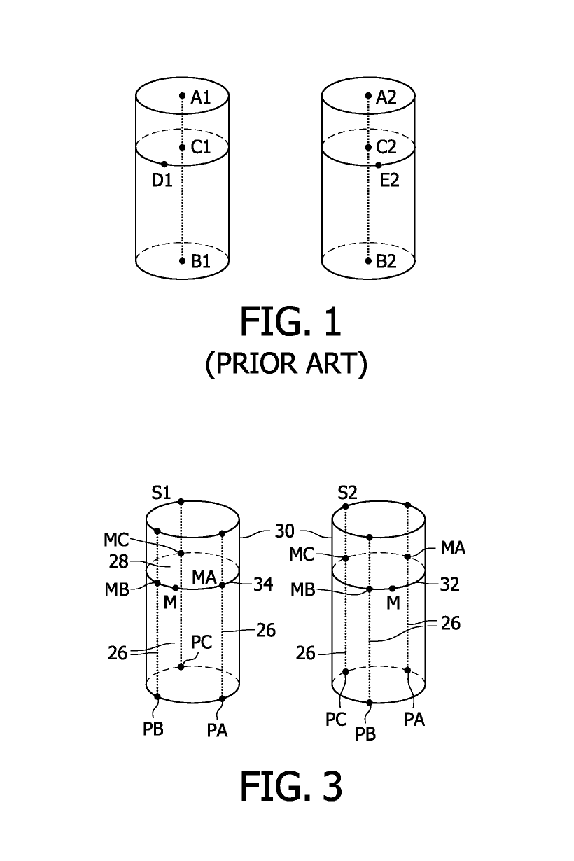

In order to explain this existing registration process in more detail, a schematic illustration of two scanned images of a tubular structure representing a colon is shown in FIG. 1. The images represent the colon in the prone and supine orientations respectively.

The centerline approach determines the lines A1-B1 and A2-B2 for the two tubular structures. Based on these lines, the existing registration method is able to determine that a point C1 in the left tubular structure corresponds to point C2 in the right tubular structure.

However, the existing technique is unable to find the point in the right hand tubular structure corresponding to point D1 of the left hand structure, but is only able to determine that all of the points on the circle containing D1 map onto the points of the circle containing point E2. In practice, this has the significant disadvantage that if a lesion is located at location D1 on one of the scans of the colon, the radiologist still has the task of inspecting the whole circle containing point E2 to determine the lesion corresponding to that at location D1. This therefore means that the correlation of results of two scans is still a time consuming operation, and also hinders any attempt to automate this process.

It is an object of the present invention to provide an improved process for correlating data representing first and second 3 D images of a tubular object.

According to an aspect of the present invention, there is provided an apparatus for correlating data representing first and second 3 D images of at least part of a tubular object, the apparatus comprising:
at least one first input for receiving first data representing said first 3 D image of at least part of said object;
at least one second input for receiving second data representing said second 3 D image of at least part of said object;
at least one processor, connected to at least one said first input and at least one said second input, for:
(i) processing said first data to provide third data corresponding to said first 3 D image of a plurality of identifiable first locations on an internal surface of said object;
(ii) processing said second data to provide fourth data corresponding substantially to said second 3 D image of said plurality of identifiable first locations;
(iii) processing said first and third data to provide fifth data representing a position of at least one predetermined second location in said first 3 D image relative to at least one said identifiable first location in said first 3 D image; and
(iv) processing said second, fourth and fifth data to provide sixth data corresponding substantially to the or each said relative location represented by said fifth data, to identify a respective third location in said second 3 D image corresponding substantially to the or each said predetermined second location in said first image.

This provides the advantage of enabling accurate correlation between the first and second 3 D images by using reference points on the wall of the tubular object, which provide a more accurate correlation between two 3 D images than reference points on a medial axis of the object. In the particular case of the tubular object being a colon, this provides the advantage that a radiologist does not need to inspect an annular strip in the second 3 D image to locate a position corresponding to a point in the first 3 D image.

The apparatus may further comprise at least one comparator apparatus for comparing said first data representing at least one said predetermined second location with said second data representing a respective said third location corresponding to the or each said second location.

At least one said processor may be adapted to identify said first data representing features of said internal wall having shape index within a predetermined range, and said second data representing features of said internal wall having shape index within a predetermined range, respectively.

This provides the advantage of enabling irregularly shaped parts of the tubular object to be identified automatically to provide reference points.

At least one said processor may be adapted to identify first and second data representing furthest apart pairs of points on at least one ridge structure.

In the case of imaging of the colon, this provides the advantage of enabling points on the teniae coli, the muscles running longitudinally of the colon, to be automatically identified to provide a set of reference points, since the furthest apart points on each colon fold are located on the teniae coli.

The apparatus may further comprise at least one compensating apparatus for compensating for limited movement of said object between formation of said first and second data.

For example, in the case of imaging of the colon, this provides the advantage of enabling compensation for limited movement of the patient during imaging.

At least one said compensating apparatus may be adapted to adjust third and/or fourth data corresponding to the plurality of said identifiable first locations such that mean position values of data representing a plurality of said first locations represented by said third and or fourth data are substantially equal.

For example, average X, Y and/or Z co-ordinates of a plurality of reference points in the first 3 D image can be made substantially equal to those in the second 3 D image.

At least one said processor may be adapted to determine a respective distance along said internal wall from the or each said second location to at least one said identifiable first location.

At least one said processor may be adapted to identify a respective fourth location within a respective predetermined distance of at least one said third location.

According to another aspect of the present invention, there is provided an imaging apparatus comprising at least one imaging device for obtaining data representing first and second 3 D images of at least part of a tubular object, an apparatus as defined above, and at least one display apparatus for displaying said first and second 3 D images of at least part of said object.

According to a further aspect of the present invention, there is provided a data structure for use by a computer system for correlating data representing first and second 3 D images of at least part of a tubular object, the data structure comprising:
first computer code executable to receive first data representing said first 3 D image of at least part of said object;
second computer code executable to receive second data representing said second 3 D image of at least part of said object;
third computer code executable to process said first data to provide third data corresponding to said first 3 D image of a plurality of identifiable first locations on an internal surface of said object;
fourth computer code executable to process said second data to provide fourth data corresponding substantially to said second 3 D image of said plurality of identifiable first locations;
fifth computer code executable to process said first and second data to provide fifth data representing the position of at least one predetermined second location in said first 3 D image relative to at least one said identifiable first location in said first 3 D image; and
sixth computer code executable to process said second, fourth and fifth data to provide sixth data, corresponding substantially to the or each said relative location represented by said fifth data, to identify a respective third location in said second 3 D image corresponding substantially to the or each said predetermined second location in said first image.

The data structure may further comprise seventh computer code executable to compare said first data representing at least one said predetermined location with said second data representing a corresponding said third location.

Said third and fourth computer code may be executable to identify said first data representing features of said internal wall having shape index within a predetermined range, and said second data representing features of said internal wall having shape within a predetermined range, respectively.

Said third computer code may be executable to correlate first and second 3 D images of at least part of the colon, and to identify first and second data representing furthest apart pairs of points on at least one ridge structure.

The data structure may further comprise eighth computer code executable to compensate for limited movement of said object between formation of said first and second data.

Said eighth computer code may be executable to adjust said third and/or fourth data corresponding to the plurality of said identifiable first locations such that mean position values of data representing a plurality of said first locations represented by said third and or fourth data are substantially equal.

The fifth computer code may be executable to determine a respective distance along said internal wall from the/or each said second location to at least one said identifiable first location.

The sixth computer code may be executable to identify a respective fourth location within a respective predetermined distance of at least one said third location.

According to a further aspect of the present invention, there is provided a computer readable medium carrying a data structure as defined above stored thereon.

According to a further aspect of the present invention, there is provided a method of correlating data representing first and second 3 D images of at least part of a tubular object, the method comprising:
receiving first data representing said first 3 D image of at least part of said object;
receiving second data representing said second 3 D image of at least part of said object;
processing said first data to provide third data corresponding to said first 3 D image of a plurality of identifiable first locations on an internal surface of said object;
processing said second data to provide fourth data corresponding substantially to said second 3 D image of said plurality of identifiable first locations;
processing said first and third data to provide fifth data representing the position of at least one predetermined second location in said first 3 D image relative to at least one said identifiable first location in said first 3 D image; and
processing said second, fourth and fifth data to provide sixth data corresponding substantially to the or each said relative location represented by said fifth data, to identify a respective third location in said second 3 D image corresponding substantially to the or each said predetermined second location in said first image.

The method may further comprise the step of comparing said first data representing at least one said predetermined second location with said second data representing a respective corresponding said third location.

The step of providing said third data may comprise identifying said first data representing features of said internal wall having shape index within a predetermined range, and the step of providing said fourth data may comprise identifying said second data representing features of said internal wall having shape index within a predetermined range.

The method may be a method of correlating first and second 3 D images of at least part of the colon, and may further comprise identifying first and second data representing furthest apart pairs of points on at least one ridge structure.

The method may further comprise the step of compensating for limited movement of said object between formation of said first and second data.

The compensating step may comprise adjusting said third and/or fourth data corresponding to the plurality of said identifiable first locations such that mean position values of data representing a plurality of said first locations represented by said third and or fourth data are substantially equal.

The step of providing said fifth data may comprise determining a respective distance along said internal wall from the or each said second location to at least one said identifiable first location.

The step of providing said sixth data may comprise identifying a respective fourth location within a respective predetermined distance of at least one said third location.

By comparing said first and second data, this provides the advantage of enabling erroneous results such as false positive detections of irregularities to be more rapidly detected, which in turn enables more rapid correlation of the first and second 3 D images.

A preferred embodiment of the invention will now be described, by way of example only and not in any limitative sense, with reference to the accompanying drawings, in which:

FIG. 1 is a schematic representation of an existing process for registration of scanned images of a tubular object representing the colon in prone and supine orientations;

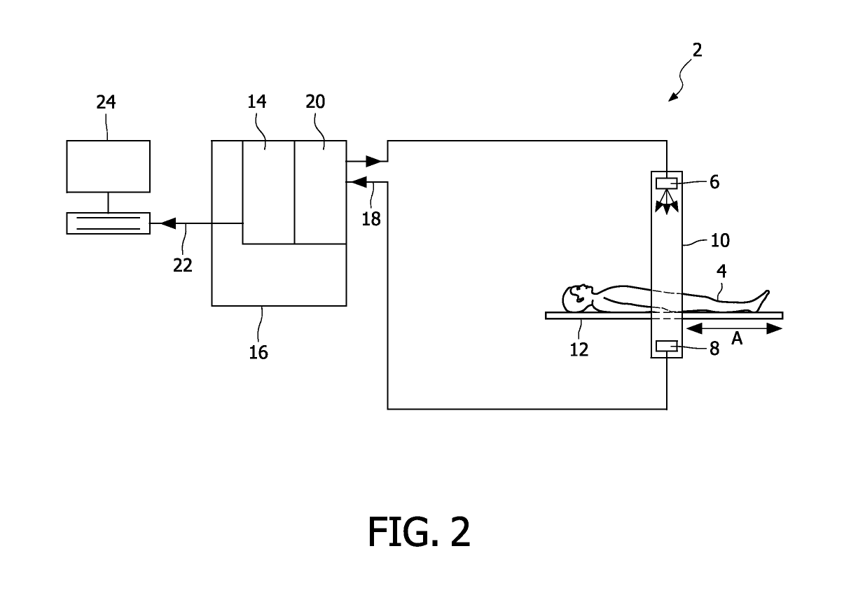

FIG. 2 is a schematic representation of a computer tomography (CT) colon imaging apparatus embodying the present invention;

FIG. 3 is a schematic representation, corresponding to FIG. 1, of scanned images illustrating the principle of operation of the present invention;

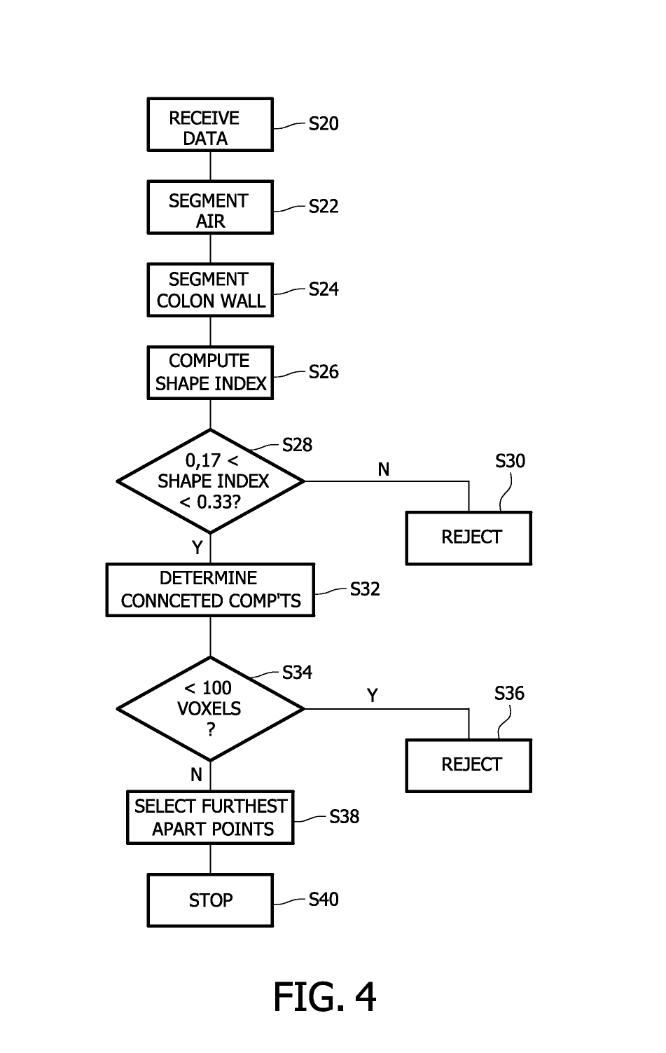

FIG. 4 is a flow diagram showing execution by the apparatus of FIG. 2 of an algorithm for selecting reference points on an internal surface of the colon;

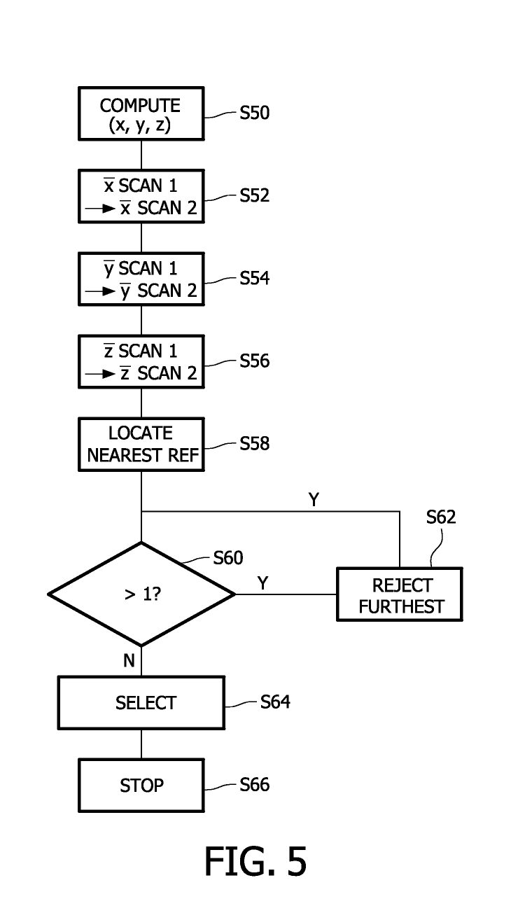

FIG. 5 is a flow diagram showing execution by the apparatus of FIG. 2 of an algorithm for matching the reference points of a first scan of the colon with those of a second scan; and

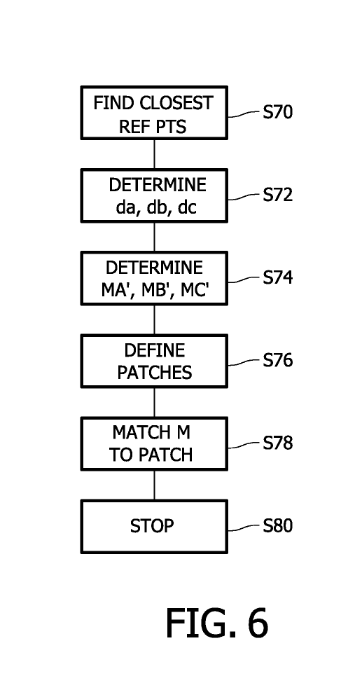

FIG. 6 is a flow diagram showing execution by the apparatus of FIG. 2 of an algorithm for matching an arbitrary point in the first scan of the colon with a corresponding point in the second scan.

Referring to FIG. 2, a computer tomography (CT) scanner apparatus 2 for forming a 3 D imaging model of the colon of a patient 4 has an array of x-ray sources 6 and detectors 8 arranged in pairs in a generally circular arrangement around a support 10. The apparatus is shown from the side in FIG. 2, as a result of which only one source/detector pair can be seen.

The patient 4, having previously been treated by methods familiar to persons skilled in the art to evacuate the colon and inflate the colon with air, is supported on a platform 12 which can be moved, by suitable means (not shown) under the control of a control unit 14 forming part of a computer 16, in the direction of arrow A in FIG. 2. The control unit 14 also controls operation of the sources 6 and detectors 8 for obtaining image data of a thin section of the patient's body, and movement of the patient 4 relative to the support 10 is synchronized by the control unit 14 to build up a series of images of the part of the patient's body to be examined, in the present case the abdomen.

The image data obtained from the detectors 8 is input via input line 18 to a processor 20 in the computer 16, and the processor builds up a 3 D model of the patient's colon from the data image slices input along input line 18 for both the prone and supine positions of the patient. The processor 20 also outputs 3 D images along output line 22 to a suitable monitor 24.

Referring to FIG. 3, which shows representations S1, S2 of a 3-D image of the patient's colon taken in the prone and supine positions, the imaging apparatus 2 obtains image data corresponding to points running along the teniae coli 26, i.e. the three longitudinal muscles that run the entire length of the colon. With particular reference to FIG. 4, the operation of an algorithm for determining reference points on the teniae coli 26 for each scan is described. The processor receives the image data at step S20 and determines at step S22 the voxels corresponding to the air filled regions of the colon, since the air is easier than tissue to detect by means of the CT apparatus. The image data corresponding to the colon wall is then determined in step S24 by determining those voxels that neighbor the voxels representing the air in the colon.

The image data representing the colon folds is then determined by computing the shape index of the colon wall voxels at a scale of 2 mm at step S26, and it is determined at step S28 whether the shape index of the selected voxels is between 0.17 and 0.33, corresponding to the selection of voxels on ridge structures. If the detected shape index lies outside the range of 0.17 to 0.33, the selected voxel is rejected at step S30, whereas if the voxel is within the desired range, the connected components in the selected voxels are determined at step S32 to provide a number of objects.

It is determined at step S34 whether each object has less than 100 voxels, and any object having less than 100 voxels is rejected at S36. The remaining object, having 100 or more voxels, represent scanned image data of the colon folds, which are generally triangular in outline. For each fold, the two points that are furthest apart are selected at step S38, these points being the fold extremities. The extremities are located on the teniae coli, the three muscles running generally longitudinally of the colon, as a result of which the points selected at step S38 are points on the teniae coli, and the process ends at step S40.

Referring now to FIG. 5, the reference points in the first scan S1 are matched with the corresponding reference points in the second scan S2 by means of the algorithm shown. In particular, the X, Y and Z co-ordinates in a Cartesian system are computed for each of the reference points detected in the algorithm of FIG. 4 at step S50. In order to compensate for limited movement of the patient in the scanner, the X co-ordinates of the reference points are adjusted in step S52 such that the mean of the X co-ordinates of the reference points in the first scan S1 is equal to the mean of the X co-ordinates of the reference points in the second scan S2. Operations corresponding to the operation carried out in step S52 are then carried out for the Y and Z co-ordinates at steps S54 and S56 respectively.

For each of the reference points in the first scan S1, the nearest reference point in the other scan S2 is located at step S58, and it is determined for each reference point at step S60 whether there is one or more than one nearest reference point. If it is determined at step S60 that the point in the first scan corresponds to more than one point in the second scan, the point in the first scan that is furthest away from the point in the second scan is rejected at step S62 and step S60 is repeated for the next reference point. By discarding one of more of the reference points in this way, this provides the advantage of compensation for change of shape or flattening of the colon folds. If, however, the reference point in the first scan corresponds to only one reference point in the second scan, the reference point is selected at step S64 and the process ends at step S66. In this way, for any given point M in the first scanned image S1, the nearest reference points MA, MB, MC on the teniae coli 26 are determined by means of the algorithm of FIG. 5.

The points MA′, MB′, MC′ (FIG. 3) corresponding to MA, MB and MC on second scan S2 are then determined, these points lying on a curve 32. As shown in greater detail in FIG. 6, and as shown in FIG. 3, for arbitrary point M on the colon wall in the first scan, the three closest reference points detected by means of the algorithms of FIGS. 4 and 5 are determined at step S70, these being points MA, MB and MC as shown in FIG. 3. At step S72, the distances along the colon surface from point M to MA, MB and MC are determined as distances da, db and dc respectively.

The reference points MA′, MB′, MC′ in the second scan corresponding to points MA, MB, MC respectively in the first scan are then determined in step S74. In step S76, in order to take account of minor changes in the shape of the colon folds, for each of the points MA′, MB′, MC′, a patch around each of the points containing points on the colon wall a distance along the colon wall of da+0.1 da, db+0.1 db, and dc+0.1 dc respectively are defined. Finally, in step S78, point M is matched to any of the points in the area defined by the intersection of the three patches defined in step S76, and the process ends at S80.

The results of the scan in the prone position can be checked against the results of the scan in the supine position by matching points relative to the three longitudinal muscles. For example, this can be achieved by a radiographer viewing two separate images on display 24, or can be carried out automatically by processor 20. When the results match each other, they are given a high weighting score to indicate that the probability that the imaging apparatus 2 made a false detection is small, and if the results do not match, they receive a low weighting score. These scores can be later combined with other measures for deciding whether a result corresponds to a real lesion, or a false positive, for example caused by the presence of stool in the colon.

In addition, the apparatus 2 can generate a fly-through visualization of the colon, and one or both of the images displayed on monitor 24 can be rotated about its medial axis such that points on the two reference muscles 26 in each scan S1, S2 occupy the same position relative to the visualization window on the monitor 24. This can be achieved by means of processor 20 or by means of an additional processor (not shown) associated with the monitor 24. This causes the folds of the colon to have the same orientation in the visualization window, resulting in a more regular pattern, and any lesion will therefore appear as a defect in this regular pattern and can be more easily detected.

It will be appreciated by persons skilled in the art that the above embodiment has been described by way of example only and not in any limitative sense, and that various alterations and modifications are possible without departure from the scope of the invention as defined by the appended claims. For example, as well as correlating 3 D images of the colon in first and second orientations, the present invention can be used to correlate 3 D images in the same orientation over time to monitor the development of a lesion, or may be used to correlate a 3 D image of an test object with that of a standard or normal object. Also, the invention may be used to correlate 3 D images of any other tubular physiological structure, such as the trachea, lungs or oesophagus or arteries.

1-26. (canceled)

27. A method of registering a first scan (S1) and a second scan (S2) of the colon taken in a prone and supine orientation, respectively, the method comprising the steps of:
determining reference points in the first scan and in the second scan;
matching the first scan reference points (MA; MB; MC) with the second scan reference points (MA′; MB′; MC′); and
registering the first scan (S1) and the second scan (S2) on the basis of the matched first scan and second scan reference points.

28. A method as claimed in claim 27, wherein the step of determining the reference points comprises the steps of:
determining (S22) air-filled regions of the colon in the first scan and in the second scan;
determining (S24) a colon wall in the first scan and in the second scan based on the air-filled regions;
determining colon folds in the colon wall in the first scan and in the second scan; and
determining (S38) fold extremities in each colon fold from the determined colon folds in the first scan and in the second scan, thereby determining the reference points in the first scan and in the second scan.

29. A method as claimed in claim 28, wherein the step of matching the first scan reference points with the second scan reference points comprises the steps of:
adjusting (S52; S54; S56) the first scan and second scan reference points; and
locating the nearest second scan reference point for each first scan reference point, thereby matching the first scan reference points with the second scan reference points.

30. A method as claimed in claim 29, wherein the step of registering the first scan and the second scan comprises the step of matching a point (M) on the first scan colon wall with a point on the second scan colon wall based on the matched reference points.

31. An apparatus for registering a first scan (S1) and a second scan (S2) of the colon taken in a prone and supine orientation, respectively, the apparatus comprising:
a determination unit for determining reference points in the first scan and in the second scan;
a match unit for matching the first scan reference points (MA; MB; MC) with the second scan reference points (MA′; MB′; MC′); and
a registration unit for registering the first scan (S1) and the second scan (S2) on the basis of the matched first scan and second scan reference points.

32. A data structure for use by a computer system for registering a first scan (S1) and a second scan (S2) of the colon taken in a prone and supine orientation, respectively, the apparatus comprising:
a first computer code for determining reference points in the first scan and in the second scan;
a second computer code for matching the first scan reference points (MA; MB; MC) with the second scan reference points (MA′; MB′; MC′); and
a third computer code for registering the first scan (S1) and the second scan (S2) on the basis of the matched first scan and second scan reference points.

33. A computer readable medium carrying a data structure as claimed in claim 32.
